(19) United States
(12) Patent Application Publication
(10) Pub. No.: US 2018/0168206 A1
(43) Pub. Date: Jun. 21, 2018

(54) SYSTEMS AND APPARATUSES FOR MELTING SUGAR AND/OR SIMILAR SUBSTANCES, AND ASSOCIATED METHODS OF USE AND MANUFACTURE

(71) Applicant: C. Cretors & Company, Wood Dale, IL (US)

(72) Inventors: Charles D. Cretors, Lake Forest, IL (US); Tom Kremmydas, Wood Dale, IL (US); Frank Strawn, Deer Creek, IL (US)

(21) Appl. No.: 15/380,928

(22) Filed: Dec. 15, 2016

(51) Int. Cl. A23L 7/183

(52) U.S. Cl. CPC A23L 7/183; A23V 2002/00

(57) ABSTRACT

Apparatuses for melting sugar and similar ingredients for use in the production of sugar-coated popcorn and/or other expanded food products are described herein. In various embodiments, a sugar melter can include a rotating, heated auger that moves sugar through the melter causing it to melt evenly without forming unmelted portions that may clog the melter and/or lead to waste. Various configurations of machines that can produce sugar-coated popcorn with the disclosed sugar melters are also described herein.

### TECHNICAL FIELD

The following disclosure relates generally to systems and apparatuses for melting sugar and, more particularly, to apparatuses for melting sugar and associated systems for use with popcorn machines and the like.

### BACKGROUND

Popcorn machines for use in theaters, concession stands, and homes are well known. Industrial machines for making large quantities of popcorn, puffed rice, and other expanded food products for wholesale to retailers are also known. Conventional popcorn machines typically include a popping kettle positioned inside a cabinet. To make popcorn, unpopped corn kernels are placed in the kettle with cooking oil and heated with a gas or electric heating element. The cooking oil coats the kernels and ensures a relatively even distribution of heat, and rotating blades or other agitating devices mix the kernels with the cooking oil to ensure the kernels are evenly heated for popping.

“Continuous” popcorn popping machines for popping corn in, for example, industrial applications are also known. Such machines can include a feed end that receives unpopped corn kernels, a rotating auger that moves the corn kernels in hot oil along a cooking surface (e.g., a trough) having a semi-circular cross-section, and a discharge end that discharges the popped popcorn. Such machines are disclosed in, for example, U.S. patent application Ser. No. 13/452,764, titled “POPCORN POPPING MACHINES AND OTHER MACHINES HAVING FLOW-THROUGH DECKS FOR POPPING POPCORN AND PRODUCING OTHER TYPES OF EXPANDED FOOD,” filed Apr. 20, 2012, and incorporated herein by reference in its entirety.

Popcorn and other expanded food products (e.g., puffed rice, etc.) are often coated with sugar. “Kettle corn,” for example, is a popular popcorn product with a light coating of sugar. In conventional systems for making kettle corn, granulated sugar is added to a kettle of corn kernels and oil, and the kettle heats the sugar, oil and corn kernels together. During the heating process, the sugar melts and coats the popped corn. One drawback to this process, however, is that “sugar balls” or clumps of hard sugar that have not melted properly can form in the kettle. Although most of the sugar balls are sifted out of the popped corn and lost as waste, occasionally some will inadvertently be included with the packaged product, which can be undesirable to consumers. Additionally, the kettle may require frequent cleaning to remove the buildup of sugar balls.

The presence of sugar balls and other un-melted clumps of hard sugar can also be problematic in continuous popping machines. For example, in the continuous popper described above solid sugar can adhere to portions of the rotating auger. As the auger rotates, the sugar is drawn from the heated oil bath on the auger blade, and cools as the auger blade rotates away from the heated oil. The cooled and solidified sugar then re-enters the heated bath of oil and sugar, and consequently picks up additional sugar and then cools again. This creates clumps of hardened, un-melted sugar that can eventually break off of the auger and, if not sifted out of the discharged product, can be inadvertently included in the packaged product. Accordingly, it would be advantageous to provide an apparatus for efficiently producing melted sugar for application to popcorn and/or other expanded food products.

### BRIEF DESCRIPTION OF THE DRAWINGS

FIGS. 1A and 1B are isometric views of a sugar melter configured in accordance with an embodiment of the present technology.

FIG. 2 is an enlarged isometric view of a drive portion of the sugar melter of FIGS. 1A and 1B, with one or more external parts removed for clarity.

FIGS. 3A and 3B are enlarged, cross-sectional isometric views of an outlet portion of the sugar melter of FIGS. 1A and 1B.

FIG. 4A is a partially schematic side view of the sugar melter of FIGS. 1A and 1B configured in accordance with an embodiment of the present technology, and FIG. 4B is an isometric view of the sugar melter with one or more exterior parts removed for clarity.

FIG. 5 is a side elevation view of a popcorn machine having a sugar melter configured in accordance with an embodiment of the present technology.

FIG. 6 is a side elevation view of another popcorn machine having a sugar melter configured in accordance with an embodiment of the present technology.

The Appendix includes additional figures and photos illustrating various aspects of embodiments of the present technology.

### DETAILED DESCRIPTION

The following disclosure describes various embodiments of systems, apparatuses and associated methods for melting sugar to be used with, for example, industrial and commercial popcorn machines. As described in greater detail below, in some embodiments sugar melters configured in accordance with the present technology can include a vertically disposed melting chamber having a heated auger that rotates within a cylindrical tube. Sugar (e.g., granulated sugar) can be introduced into the mouth of the tube, and driven downwardly by the heated auger. As the sugar travels downwardly, it melts to a liquid or semi-liquid state before being discharged through an outlet at the bottom of the tube. The liquid or semi-liquid melted sugar can then be dispensed into, for example, a popcorn machine to produce sugar-coated popcorn (e.g., “kettle corn”) with less tendency to form sugar balls or other undesirable forms of hardened sugar.

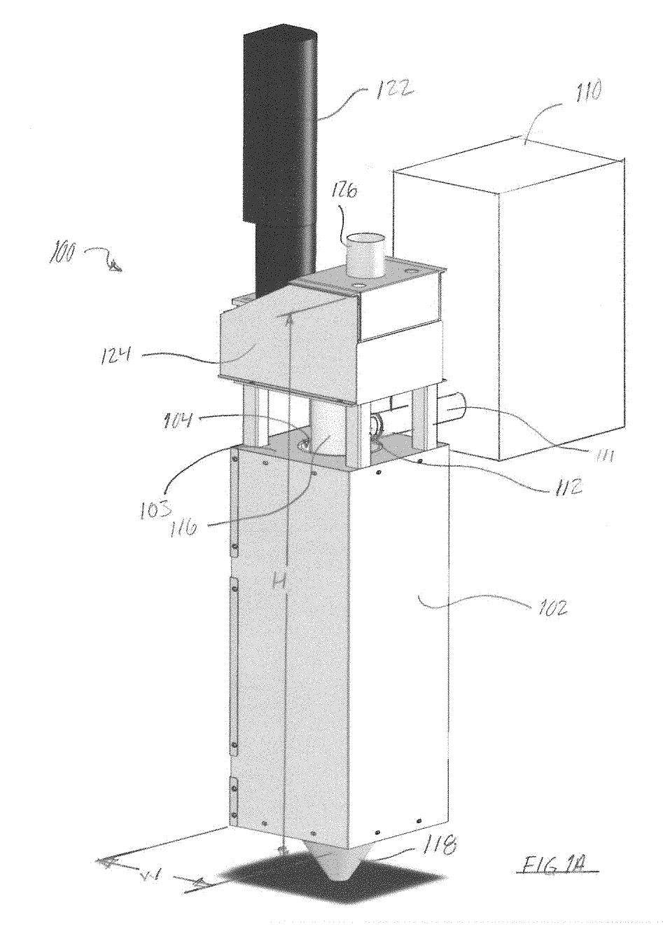

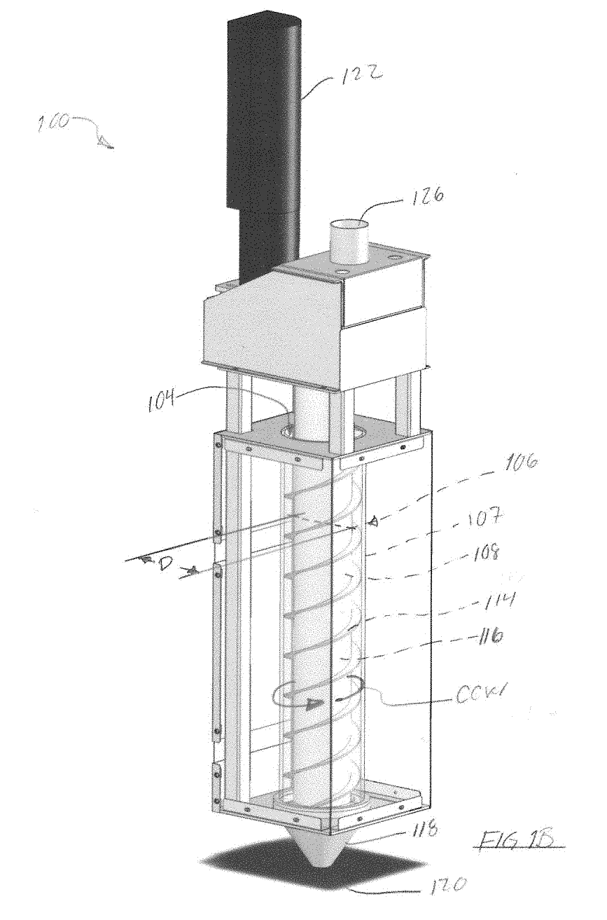

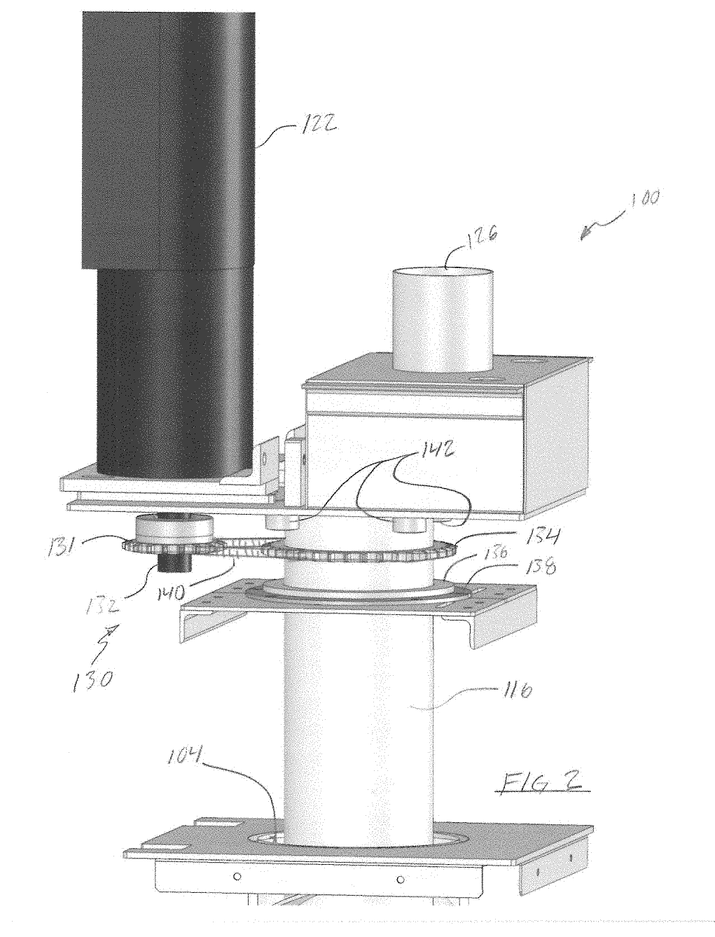

Certain details are set forth in the following description and in FIGS. 1-6 to provide a thorough understanding of various embodiments of the present technology. In other instances, well-known structures, materials, operations and/or systems often associated with sugar melters, popcorn machines, and other industrial, commercial and home food processing equipment are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is an isometric view of a sugar melter 100 configured in accordance with an embodiment of the present technology, and FIG. 1B is the isometric view of FIG. 1A with a number of exterior panels or structures either removed or made transparent to better illustrate various internal components of the sugar melter 100. Referring to FIGS. 1A and 1B together, in the illustrated embodiment the sugar melter 100 includes a vertically arranged melting chamber 106 having a conveyer (e.g., a rotating auger 108) centrally disposed in a cylindrical tube 107. As shown in FIG. 1A, the melting chamber 106 can be enclosed within a lower cover 102 (which can, for example, act as a heat shield). The auger 108 includes a helical blade (e.g., flighting 114) that extends in a helical path around a hollow central shaft 116. More specifically, in the illustrated embodiment, the flighting 114 angles downwardly as it extends around the central shaft 116 in the clockwise direction CW (when viewed from above). A top cover 103 defines an annular opening 104 between the inner wall of the cylindrical tube 107 and the outer wall of the central shaft 116.

In the illustrated embodiment, a sugar hopper 110 contains sugar (e.g., unmelted granulated sugar) for melting by the sugar melter 100. More specifically, the sugar hopper 110 includes an internal volume in communication with a dispensing tube 111 (e.g., a cylindrical tube) having an outlet 112 positioned directly above the inlet opening 104 of the melting chamber 106. In operation, the sugar hopper 110 can include a gate or a valve that controls the flow of sugar from the hopper 110 into the melting chamber 106 via the dispenser outlet 112. Additionally, the sugar hopper 110 and/or the dispensing tube 111 can be moveable relative to the sugar melter 100 so that the dispensing outlet 112 can be moved away from the melter 100 for cleaning of the auger 108 and/or other components of the melting chamber 106. For example, in some embodiments the sugar hopper 110 can be a stand-alone unit equipped with casters so that it can be rolled up next to the sugar melter 100 for use or moved away for cleaning, service, etc. In some embodiments, the sugar hopper 110 can be positioned at floor level and equipped with a conveyor (such as a rotating auger (not shown)), so that an operator can manually maintain a level of sugar in the hopper without having to climb a ladder or work platform. The rotational speed of the auger in the sugar hopper 110 can be regulated by a Variable Frequency Drive (VFD) to adjust the flow of sugar from the hopper 110 into the sugar melter 110. In other embodiments, the sugar hopper 110 can be mounted to a frame of the sugar melter 100 and require the operator to work from an elevated platform or ladder to manually load sugar into the hopper 110 and maintain an adequate level of sugar.

The term “sugar” is generally used herein for ease of reference to refer to all sugars and/or other similar substances that can be efficiently melted by the sugar melter 100 for use in the production of popcorn and other food products. For example, the term “sugar” can include sucrose in the form of granulated sugar, raw sugar and/or brown sugar, and/or other sweet, short-chain, soluble carbohydrates with or without added flavorings or ingredients, etc. Accordingly, those of ordinary skill in the art will appreciate that the melter technologies described herein are not limited to use with a particular type of sugar or other substance, and is contemplated for use with a wide variety of substances used in the production of popcorn and other foods.

As described in greater detail below, the sugar melter 100 can additionally include a motor 122 (e.g., servomotor) that controls the speed and direction of rotation of the auger 108 via a drive mechanism (not shown in FIG. 1A or 1B) enclosed within an upper cover 124. In other embodiments, the auger speed and direction can be controlled by other drive systems, such as a VFD, a standard 4 pole, electric motor/gearbox or gear motor, etc. Additionally, the upper cover 124 can form an exhaust hood and duct that directs fumes and/or effluent from the sugar melting process away from the melter 100 via an exhaust outlet 126. As also described in greater detail below, in the illustrated embodiment the lower portion of the sugar melter 100 includes an outlet (e.g., a discharge funnel 118) having an outlet opening 120.

By way of example, the various components of the sugar melter 100 described above can be formed from suitable materials joined together in a conventional manner. For example, the various components of the melting chamber 106, the sugar hopper 110, as well as other parts of the sugar melter 100 can be formed from stainless steel materials suitable for use with food processing equipment. The formed materials can be joined together by welding and/or suitable fasteners. In other embodiments, various parts of the sugar melter 100 can be formed from other suitable materials, e.g., synthetic and polymeric materials, in a conventional manner. In some embodiments, the sugar melter can have a height H of from about 18 inches to about 60 inches, or from about 24 inches to about 60 inches, or about 44 inches; and a width W of from about 6 inches to about 24 inches, or about 8 inches to about 18 inches, or about 10 inches. The central shaft 116 can have an outside diameter of from about 2 inches to about 18 inches or more, or from about 3 inches to about 8 inches, or about 4.5 inches. As those of ordinary skill in the art will appreciate, the foregoing dimensions are provided by way of example of the relative size of the sugar melter in some embodiments. Accordingly, other embodiments of sugar melters configured in accordance with the present technology can have other sizes and/or configurations of components without departing from the spirit or scope of the present disclosure.

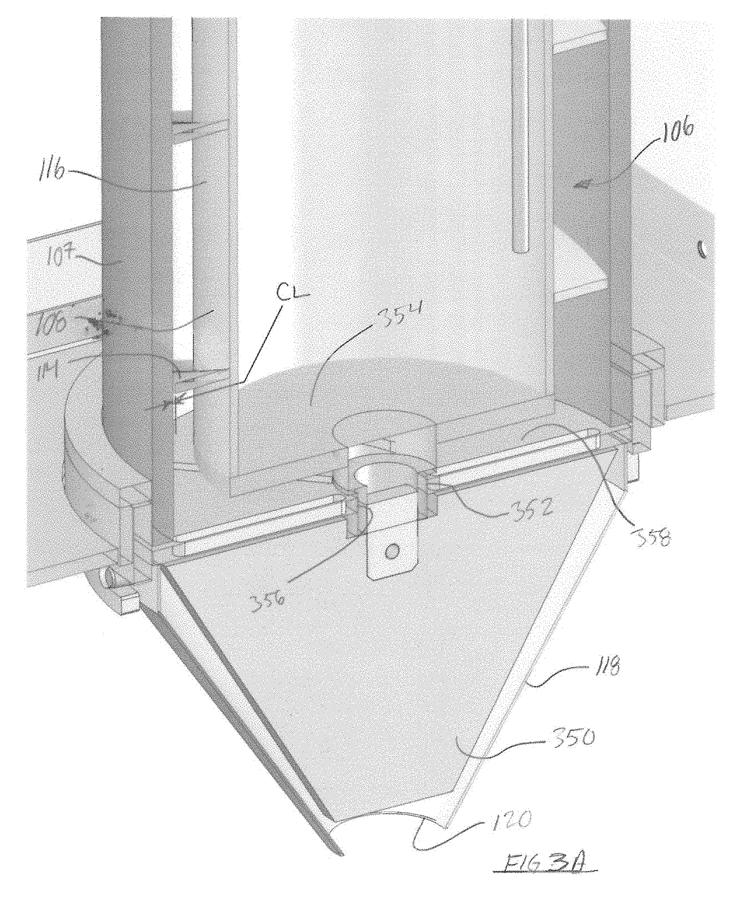

FIG. 2 is an enlarged isometric view of an upper portion of the sugar melter 100 with an upper cover 124 (FIG. 1A) removed to illustrate an auger drive system 130 configured in accordance with an embodiment of the present technology. In the illustrated embodiment, the drive system 130 includes a first sprocket 131 fixedly coupled to a drive shaft of the motor 122, and a second sprocket 134 fixedly coupled to the central shaft 116 of the auger 108. A drive member (e.g., an endless chain 140) operably couples the first sprocket 131 to the second sprocket 134. The central shaft 116 can include a circumferential support flange 136 that rides on a surface bearing 138 (e.g., a Teflon wear ring) to rotatably support the central shaft 116 in the vertical direction. Additionally, the sugar melter 100 can further include a plurality (e.g., four) rotatable ball bearings 142 evenly spaced around the circumference of the upper end of the shaft 116 to rotatably support and maintain alignment of the shaft 116 in the radial direction.

In operation, the motor 122 drives the first sprocket 131 via the motor shaft 132, and the first sprocket 131 in turn drives the second sprocket 134 via the drive member 140, which causes the central shaft 116 to rotate about its longitudinal axis. The rotational speed of the central shaft 116 can be controlled by, for example, the drive speed and direction of the motor 122, as well as the size of the first sprocket 131 relative to the second sprocket 134. In some embodiments, for example, the motor 122 can be configured to rotate the auger 108 at a speed of from about 10 revolutions per minute (RPM) to about 100 RPM, or from about 30 RPM to about 70 RPM, or about 57 RPM. The motor 122 can be configured to rotate the auger 108 in a forward direction (i.e., the counterclockwise direction (CCW) as shown in FIG. 1B) to drive sugar downwardly in the sugar melter 100 during operation. The motor 122 can also be configured to pause and/or reverse the direction of rotation of the auger 108 (i.e., rotate in the clockwise (CW) direction). In some embodiments, the motor 122 can be configured to alternate directions of rotation of the auger 108 (e.g., between CCW and CW rotation) as may be desired for efficient and satisfactory melting of the sugar, cleaning of the melting chamber 106 and associated components, and/or unjamming the auger 108. For example, in some embodiments, the motor 122 can be configured to rotate the auger 108 in the CCW direction for slightly more than 1 second, pause, rotate in the CW direction for about 1 second, and then repeat so that the auger 108 rotates slightly further overall in the CCW direction than in the CW direction. Additionally, the auger 108 can have multiple modes of operation. For example, in one embodiment the auger 108 can operate in a “Run Mode,” a “Clean Mode,” and a “Jog Mode.” The Run Mode is used for normal production, and can include continuously alternating the direction of rotation of the auger 108 between the forward and reverse directions for preset intervals of time. In other embodiments, the Run Mode can include only rotation in the forward direction, and/or varying the time periods and/or sequence of forward/reverse rotation. In the Clean Mode, water can be introduced into the melting chamber 106 via the opening 104 (FIG. 1B) for cleaning, and then the auger 108 can be rotated in, e.g., first the reverse direction for a preset period of time (e.g., 5-10 minutes) and then in the forward direction for a preset period of time (e.g., 5-10 minutes). A cover (not shown) can be attached beneath the tube 107 to direct the cleaning water away from the sugar melter 100. The Jog Mode can be used to clear clogs, prime, or run out any sugar that may still be in the melting chamber 106, and can include very short duration/high speed rotational movements of the auger 108 in forward and/or reverse directions. In other embodiments, the motor 122 can be configured to rotate the auger 108 in other operational sequences, times, speeds, etc.

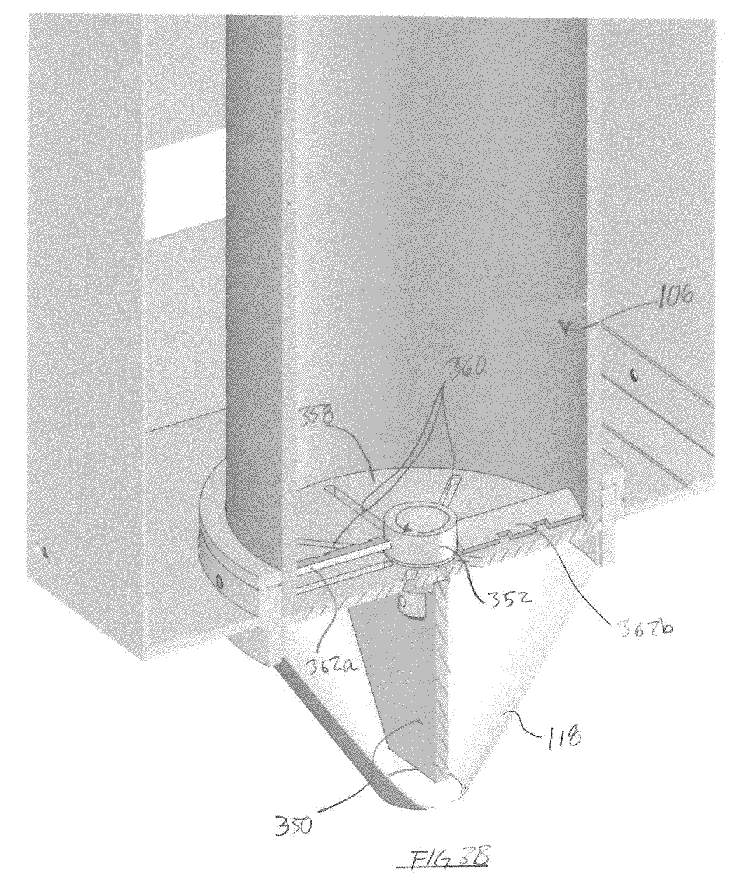

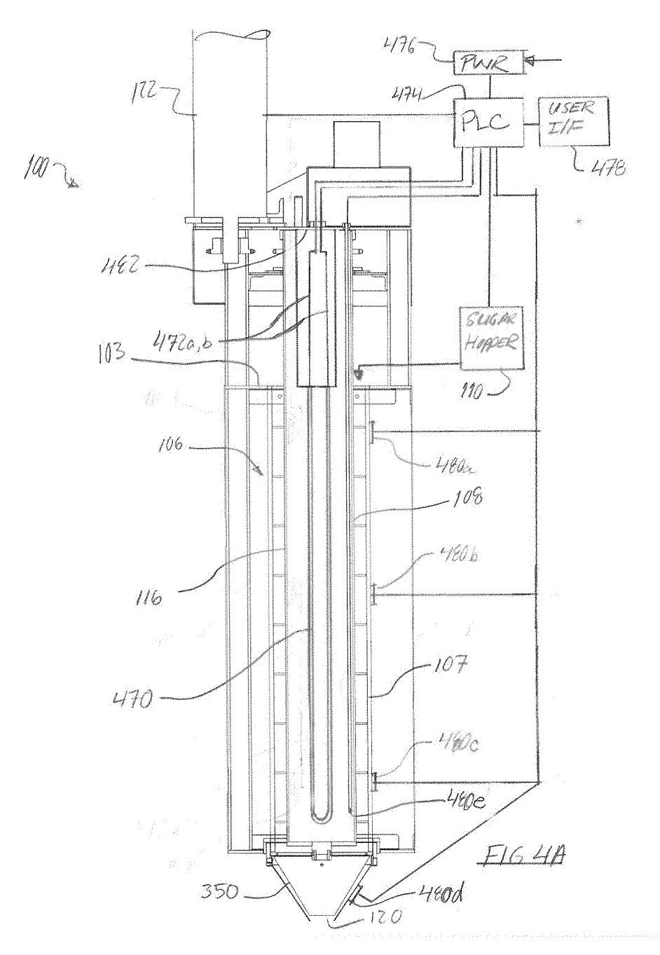

FIG. 3A is an enlarged cross-sectional isometric view of a lower portion of the melting chamber 106, and FIG. 3B is a similar cross-sectional view taken at 90 degrees to the view of FIG. 3A with the auger 108 removed for clarity. Referring first to FIG. 3A, there is a clearance CL between the outer edge of the auger flighting 114 and the inner surface of the melting chamber tube 107. In some embodiments, the clearance CL can be from about 0.01 inch to about 0.25 inch, or about 0.033 inch. As also shown in FIG. 3A, the opening at the lower end of the outer cylindrical tube 107 of the melting chamber 106 is substantially covered by a screen plate 358. The auger 108 is rotatably supported by a shoulder of a central hub 352 having a boss that is rotatably received in a cylindrical aperture 356 formed in the screen plate 358. The hub 352 extends downwardly from an end plate 354 which closes off the lower end of the central shaft 116. Accordingly, the screen plate 358 rotatably supports the auger 108 as it rotates about its central axis in operation.

Referring next to FIG. 3B, as noted above, the shaft 116 in the flighting 114 of the auger 108 have been omitted from FIG. 3B to better illustrate certain features of the screen plate 358 and the lower portion of the auger 108. More specifically, in the illustrated embodiment the screen plate 358 includes a plurality of openings 360 that enable the melted sugar to flow out of the melting chamber 106 and into the discharge funnel 118. In the illustrated embodiment, the openings 360 are elongate slots that extend radially outward from the central aperture 356. In other embodiments, the screen plate 358 can include other types of outlet openings in other configurations. Additionally, in the illustrated embodiment wipers 362 (identified individually as a first wiper 362a and a second wiper 362b) extend radially outward from the auger hub 352 directly beneath the auger end plate 354. The wipers 362 can be canted such that the trailing edge rides on, or just above, the screen plate 358, and the leading edge is spaced above the trailing edge. Moreover, the trailing edge of each of the wipers 362 can include, for example, cutouts or other features to facilitate the scraping of melted sugar off of the screen plate 358 and into the discharge funnel 118 through the openings 360. In other embodiments, the auger 108 can include other arrangements of scrapers, such as additional scrapers extending radially outward from the hub 352, as well as scrapers having other configurations. In yet other embodiments, the scrapers 362 can be omitted.

In a further aspect of this embodiment, the sugar melter 100 includes a wiper 350 fixedly coupled to a distal end of the auger hub 352 such that the wiper 350 rotates in unison with the auger 108. As shown in FIG. 3A, the wiper 350 has a truncated triangular shape that complements the conical shape of the discharge funnel 118. The outer edges of the wiper 315 are slightly inset from the inner surface of the discharge funnel 118 so that the wiper 315 can sufficiently wipe the melted sugar from the funnel walls and facilitate movement of the sugar out of the funnel 118 through the opening 120 during operation.

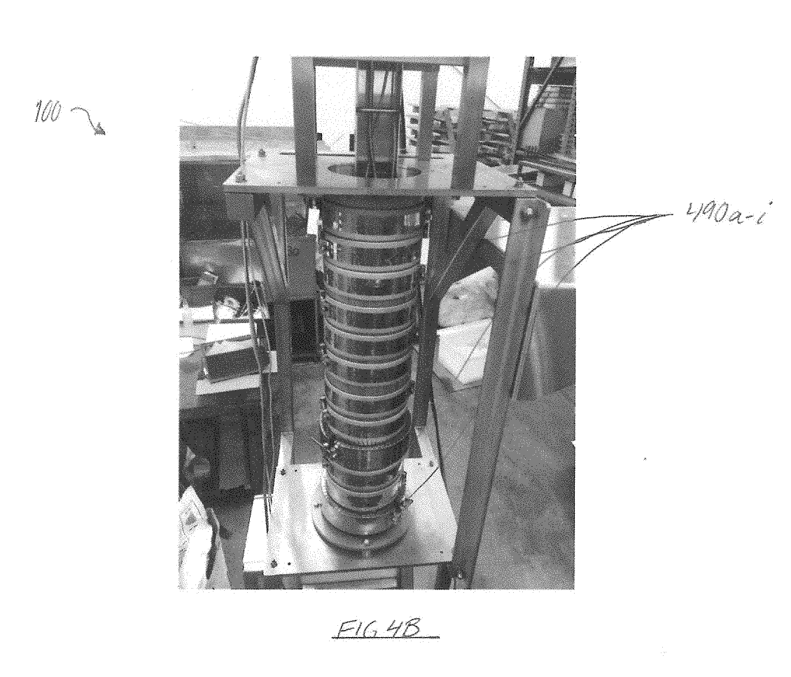

FIG. 4A is a partially schematic side cross-sectional view of the sugar melter 100 and associated systems configured in accordance with an embodiment of the present technology. In the illustrated embodiment, the sugar melter 100 and the sugar hopper 110 can be operably connected to a controller 474 that receives user inputs via a user interface 478 and power via a power source 476 (e.g., via facility power). The controller 474 can be a programmable logic controller (PLC) including a digital computer for automating, or at least partially automating, operations of the sugar melter 100 and the sugar hopper 110 in accordance with computer-readable instructions stored on memory or another non-transitory computer-readable medium. The user interface 478 can include one or more manual push buttons, selector knobs, and/or a touch screen for receiving user control inputs and settings for operation of the sugar melter 100.

In the illustrated embodiment, the auger 108 is internally heated to melt sugar by means of a heating element 470 that extends downwardly from a mounting plate 482 within the central shaft 116. More specifically, in the illustrated embodiment the heating element 470 can be a resistive heater consisting of a tubular heating element that receives power (e.g., AC power) from the controller 474 via wires 472a,b. In some embodiments, the heating element 470 can be an industrial process heater provided by the Tempco Electric Heater Corporation, 607 North Central Avenue, Wood Dale, Ill. 60191, U.S.A. For example, the heating element 470 can be a Tempco Chromalox heating element, Model No. UTUA-224LT, PCN 106016, 2000 W, 240 v. In the illustrated embodiment, the heating element 470 can have an elongate “U” shape and extend for almost the entire length, or at least the majority of the length, of the auger 108 to provide relatively even heating of the auger 108. In operation, the heating element 470 can heat the auger 108 to efficiently melt sugar moving through the melting chamber 106. In other embodiments, other types of heating elements can be used to heat the melting chamber 106 either separately or in conjunction with the internal heating element 470. For example, as shown in FIG. 4B, in some embodiments one or more heating elements can be positioned around the outside of the cylindrical tube 107 to heat the melting chamber 106. Such heating elements can include, for example, cylindrical band heaters 490a-490i that may be used in conjunction with the internal heating element 470 or in place of the heating element 470. By way of example, the band heaters 490 can include Tempco Mica Band Heaters, 1200 W, 240V, Part No. MBH00283, and/or Tempco Ceramic Band Heaters, 1100 W, 240 V, Part # BCH06431. In other embodiments, other types of band heaters and/or other heating elements can be used on the outside of the melting chamber 106, or external heating elements may be omitted.

The sugar melter 100 can additionally include one or more temperature sensors 480 (identified individually as temperature sensors 480a-e) for monitoring the temperature of the melting chamber 106 and the discharge outlet 118, and providing this information to the controller 474 to ensure efficient operation of the sugar melter 100. In the illustrated embodiment, the temperature sensors 480a-c can be coupled to the exterior surface of the outer tube 107 at various locations along its length, and the temperature sensor 480d can be coupled to the exterior surface of the discharge funnel 118. The temperature sensor 480e can be comprised of an elongate rod that extends downwardly into the central shaft 116 and is positioned adjacent to the interior wall of the central shaft 116. By way of example, the temperature sensor 480e can be an MgO insulated thermocouple provided by Pyromation, Part No. J38G-010-01A-16-F1A090-3, configured to detect the temperature proximate the distal end portion of the elongate rod. In one embodiment, for example, the sugar melter 100 can include at least one exterior temperature sensor coupled to the exterior surface of the outer tube 107 two-thirds of the way, or approximately two-thirds of the way, down the length of the outer tube 107 toward the discharge funnel 118, and at least one interior temperature sensor positioned near the interior surface of the central shaft 116 two-thirds of the way, or approximately two-thirds of the way down the length of the central shaft 116 toward the discharge funnel 118. In other embodiments, the sugar melter 100 can include more or fewer temperature sensors 480 at other locations relative to the sugar melter 100 and/or the discharge funnel 118 as necessary to suitably monitor and/or control operating temperatures. In some embodiments, the temperature sensors 480a-d can be thermocouples, such as Type J thermocouples. In other embodiments, other types of temperature sensors, including other types of thermocouples can be used. The temperature sensors 480 can provide operating temperature information to the controller 474, which can then control power to the heating element 470 according to preset logic to maintain the melting chamber 106 (and/or portions thereof) within a preset temperature range. For example, in some embodiments the melting chamber 106 can be controlled within a temperature range of from about 200 degrees F. to about 450 degrees F., or from about 300 degrees F. to about 400 degrees F., or from about 360 degrees F. to about 380 degrees F. In some embodiments, the desired operating temperature can be manually input via the user interface 478. In other embodiments, the operating temperature can be controlled by a relay logic or PLC system that, for example, automatically controls the operating temperature for automated start-up, run, stop, and clean sequences of operation.

Although specific circuitry is described above, those or ordinary skill in the art will recognize that a microprocessor-based system could also be used where any logical decisions are configured in software. Those of ordinary skill in the art will appreciate that the functions and methods described above can be implemented as an application specific integrated circuit (ASIC), by a digital signal processing (DSP) integrated circuit, through conventional programmed logic arrays or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

Referring to FIGS. 1A-4B together, in operation a user can turn the sugar melter 100 “on” via the user interface 478 to preheat the melting chamber 106 to operational temperature. Once the melting chamber 106 is at an appropriate temperature, the controller 474 can automatically (or in response to a user input) command the motor 122 to begin rotating the auger 108 in, for example, a counterclockwise direction CCW (when viewed from above) as shown in FIG. 1B. The controller 474 can also send a command to the sugar hopper 110, causing the sugar hopper 110 to dispense granulated sugar through the outlet 112 and into the opening 104 of the melting chamber 106. As the auger 108 rotates in the CCW direction, it drives the sugar downwardly through the heated melting chamber 106, causing the sugar to melt as it approaches the screen plate 358. In some embodiments, the auger 108 can periodically pause and reverse direction and rotate in the clockwise direction CW before returning to the CCW direction. Alternating the direction of rotation in this manner can ensure that the sugar is sufficiently melted before discharge. Referring to FIGS. 3A and 3B, when the melted sugar reaches the screen plate 358, it falls through the openings 360 and into the discharge funnel 118, aided by the action of the rotating wipers 362. Once in the discharge funnel 118, the rotating wiper 350 prevents the melted sugar from cooling or otherwise forming on the inner sidewalls of the discharge funnel 118, and helps to ensure that the melted sugar flows consistently through the outlet opening 120.

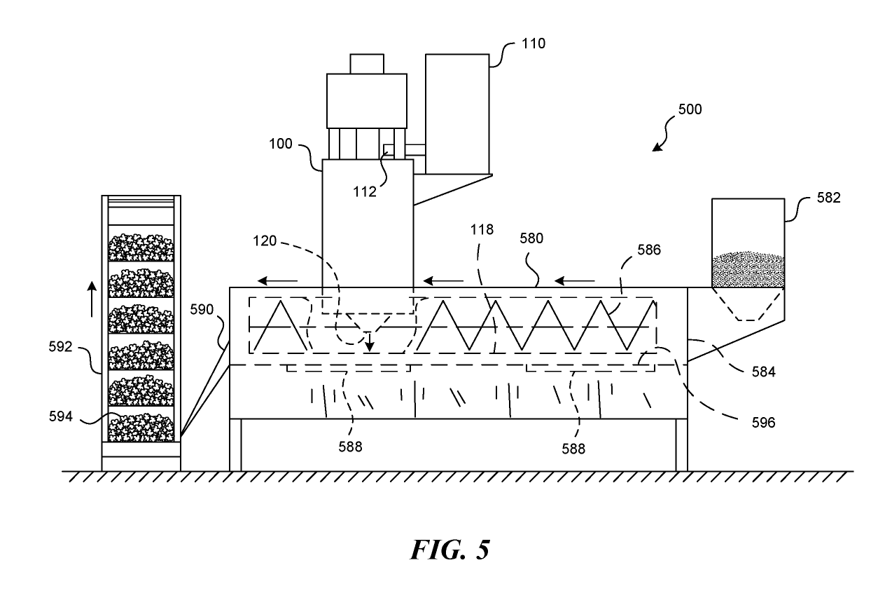

The sugar melter 100 described in detail above can be used in various types of food processing applications where food is provided with a light coating of sugar, or sugar is otherwise added to food. For example, the sugar melter 100 can be used in various types of food expanding machines, such as popcorn machines, to produce popcorn having a light coating of sugar (e.g., “kettle corn”), caramel corn, etc. FIG. 5, for example, is a side elevation view of a popcorn system 500 in which the sugar melter 100 provides melted sugar for use by a popcorn popper 580. In the illustrated embodiment, the popcorn popper 580 can include a rotatable auger 586 having a helical blade (or flighting) positioned within a trough having a semicircular cross-section that defines a cooking surface 596 heated by electric heating elements 588. In operation, the cooking surface 596 receives popcorn kernels from a corn hopper 582 via an inlet 584, and oil from an outlet (not shown) positioned proximate the inlet 584. Rotation of the auger 586 moves the corn kernels in the oil along the heated cooking surface 596 toward an outlet 590. In some embodiments, the auger 586 can alternate directions of rotation to move the corn kernels back and forth as they move along the length of the cooking surface 596. When the kernels arrive at the outlet 590, most of the them have been fully popped and coated with sugar to produce sugar-coated popcorn 594 that can be discharged onto, for example, a conveyer 592 for packaging. In some embodiments, the popcorn popper 580 can be at least generally similar in structure and function to one or more of the popcorn machines described in detail in U.S. patent application Ser. No. 12/891,722, filed Sep. 27, 2010, entitled “POPCORN MACHINES AND OTHER MACHINES HAVING REVERSIBLE FOOD MOVING DEVICES FOR POPPING POPCORN AND PRODUCING OTHER TYPES OF EXPANDED FOODS,” which is incorporated herein by reference in its entirety.

In one aspect of the illustrated embodiment, the discharge funnel 118 of the sugar melter 100 can be positioned to introduce melted sugar into the popcorn popper 580 at a position spaced apart from the inlet 584. Alternatively, the popper assembly 500 can include a conduit (not shown) that extends from the opening 120 of the discharge funnel 118 and directs the melted sugar to a desired location on the cooking surface 596. For example, in some embodiments the discharge funnel 118 of the sugar melter 100 can be positioned approximately two-thirds of the distance down the length of the popcorn popper 580 so that it introduces the melted sugar onto the cooking surface 596 at a position in which the popcorn popping process has begun. In other embodiments, the sugar melter can introduce melted sugar into the popcorn popper 580 at other locations.

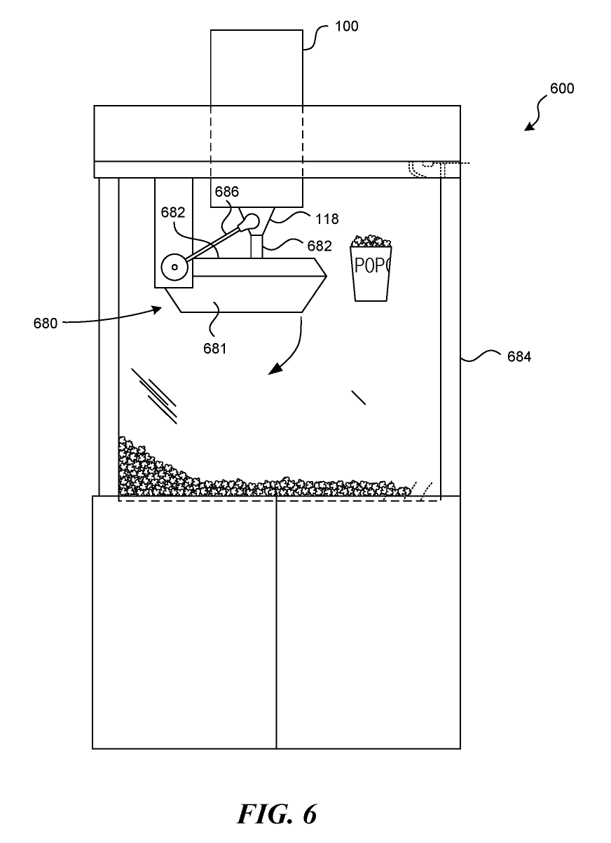

Although FIG. 5 illustrates one embodiment of popcorn popper that can utilize the sugar melter 100 in accordance with the present technology, in other embodiments various other types of popcorn poppers (including commercial, industrial, and/or residential batch poppers) can also utilize the sugar melter 100. FIG. 6, for example, illustrates another use of the sugar melter 100 in accordance with an embodiment of the present technology. More specifically, in the illustrated embodiment a popcorn system 600 includes a kettle-type popcorn popper 680 positioned within a cabinet 684. The popcorn popper 680 includes a pivotable popping kettle 681 and a kettle top 682. The sugar melter 100 includes a conduit 682 that extends from the discharge funnel 118 and through an opening in the kettle top 682. In operation, the sugar melter 100 can dispense melted sugar into the popping kettle 681 via the conduit 682 to produce sugar-coated popcorn. After the popping/coating process, the popping kettle 681 can be rotated downwardly by use of a lever 686 in a conventional manner to discharge the sugar-coated popcorn into the cabinet 684.

The Appendix includes additional photographs and drawings describing various aspects of embodiments of the sugar melter described herein, and form a part of the present disclosure.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A sugar melter as substantially described and shown herein.

2. A machine for making sugar-coated popcorn as substantially described and shown herein.

3. An apparatus for melting a food ingredient, the apparatus comprising:
an inlet configured to receive the food ingredient;
an auger configured to rotate and move the food ingredient from the inlet toward an outlet; and
at least one heating element configured to heat the food ingredient to melt the food ingredient as it moves from the inlet toward the outlet.

4. The apparatus of claim 3 wherein the food ingredient is a sugar.

5. The apparatus of claim 3 wherein the heating element is positioned inside the auger.

6. The apparatus of claim 3, further comprising a tube, wherein the auger extends within the tube, and wherein the heating element is positioned around the outside of the tube.

7. A machine for making sugar-coated popcorn, the machine comprising:
a popcorn popper; and
a sugar melter having a heated auger for moving melted sugar into the popcorn popper.

8. The machine of claim 7 wherein the popcorn popper is a continuous popper.

9. The machine of claim 7 wherein the popcorn popper is a rotary popper having an auger.
